(19) United States
(12) Patent Application Publication
(10) Pub. No.: US 2006/0138165 A1
(43) Pub. Date: Jun. 29, 2006

(54) Liquid crystal dispensing apparatus capable of measuring remaining amount of liquid crystal

(76) Inventors: Soo-Cheol Kim, Gyeongsangbuk-Do (KR); Gu-Yun Bok, Seoul (KR)

Correspondence Address: MCKENNA LONG & ALDRIDGE LLP, 1900 K STREET, NW, WASHINGTON, DC, 20006, US

(21) Appl. No.: 11/133,377

(22) Filed: May 20, 2005

(30) Foreign Application Priority Data
Dec. 28, 2004 (KR) 2004-114396

(51) Int. Cl. G01G 13/00

(52) U.S. Cl. 222/77

(57) ABSTRACT

A liquid crystal dispensing apparatus is disclosed and includes a liquid crystal material container containing liquid crystal material; a discharge pump for drawing in the liquid crystal material from the liquid crystal material container and discharging the drawn liquid crystal material; a nozzle for dispensing the discharged liquid crystal material; and a weight measuring device for measuring the weight of liquid crystal material remaining in the liquid crystal material container. The weight measuring device checks the amount of liquid crystal material remaining in the container in real time by measuring the weight of the remaining liquid crystal material in the container.

This application claims the benefit of Korean Patent Application No. 2004-114396 filed on Dec. 28, 2004, which is hereby incorporated by reference in its entirety for all purposes as if fully set forth herein.

### BACKGROUND OF THE INVENTION

1. Field of the Invention

The present invention relates to a liquid crystal dispensing apparatus, and particularly, to a liquid crystal dispensing apparatus capable of efficiently using liquid crystal material by checking the amount of liquid crystal material remaining in a liquid crystal material container in real time upon measuring the weight of the liquid crystal material contained in the container in real time.

2. Discussion of the Related Art

As various portable electric devices such as mobile phones, personal digital assistants (PDA), notebook computers, etc., continue to be developed, various types of flat panel display devices such as liquid crystal displays (LCDs), plasma display panels (PDPs), field emission displays (FEDs), and vacuum florescent displays (VFDs), having a compact construction, light weight, and low power-consumption characteristics also continue to be developed. Owing to the ease with which they are driven, and to their superior ability to display images, LCDs are extensively used.

An LCD device is a device that displays information on a screen by using refractive anisotropy. As illustrated in FIG. 1, the LCD device 1 generally comprises a lower substrate 5, an upper substrate 3 and a liquid crystal layer 7 formed therebetween. The lower substrate 5 (i.e., a driving device array substrate) includes a plurality of pixels (not shown), with a driving device (e.g., a thin film transistor (TFT)) and a pixel electrode formed at each pixel. The upper substrate 3 (i.e., a color filter substrate) includes a color filter layer for realizing color and a common electrode. An alignment layer is formed on both the lower and upper substrates 5 and 3 to align liquid crystal molecules of the liquid crystal layer 7.

The lower substrate 5 and the upper substrate 3 are attached to each other by a sealant material 9, formed at peripheral regions thereof, and the liquid crystal layer 7 is confined within an area defined by the peripheral regions. Light transmittance characteristics of the pixels are controlled by causing the driving devices to generate electric fields between the pixel electrodes and the common electrode. The generated electric fields reorient liquid crystal molecules of the liquid crystal layer 7 to display a picture.

FIG. 2 illustrates a flow chart of a related art method for fabricating the LCD device. Referring to FIG. 2, the related art method of fabricating the LCD device described above generally consists of three sub-processes: a TFT array substrate forming process; a color filter substrate forming process; and a cell forming process.

At S101, a TFT array substrate forming process is performed whereby a plurality of gate lines and data lines are formed on the lower substrate 5 (e.g., a glass substrate) to define an array of pixel areas. TFTs are connected to the gate lines and the data lines within each pixel area, and pixel electrodes are connected to the thin film transistors to drive a subsequently provided liquid crystal layer in accordance with a signal applied through the thin film transistor.

At step S104, a color filter process is performed whereby R, G and B color filter layers, for realizing predetermined colors, and a common electrode are formed on the upper substrate 3 (i.e., a glass substrate).

At steps of S102 and S105, alignment layers are formed over the entire surface of both the lower substrate 5 and upper substrate 3. Subsequently, the alignment layers are rubbed to induce predetermined surface anchoring characteristics (i.e., a pretilt angle and alignment direction) within the liquid crystal molecules of the liquid crystal layer 7.

At step S103, spacers are dispersed onto the lower substrate 5. At step S106, the sealant material is printed at peripheral regions of the upper substrate 3. At step S107, the lower and upper substrates 5 and 3 are pressed and bonded together (i.e., assembled) and the spacers dispersed at step S103 ensure that a cell gap formed between the assembled lower and upper substrates 5 and 3 is uniform.

At step S108, the assembled upper and lower substrates 5 and 3 which are large glass substrates are cut into unit panels. Specifically, the lower substrate 5 and the upper substrate 3 each include a plurality of unit panel areas, within each of which individual TFT arrays and color filters are formed.

At step S109, liquid crystal material is injected into the cell gap of each of the unit panels through a liquid crystal injection hole defined within the sealant material. After each cell gap is completely filled with liquid crystal material, the liquid crystal injection hole is sealed. At the S110, the filled and sealed unit panels are then tested. Here, the injection is made by a pressure differential.

FIG. 3 illustrates a related art liquid crystal injection system for fabricating the related art LCD device.

Referring to FIG. 3, a container 12, containing a supply of liquid crystal material 14, is placed into a vacuum chamber 10 that is connected to a vacuum pump (not shown). Subsequently, a unit panel 1 formed as described above with respect to FIG. 2, is arranged over the container 12 using a unit panel handling device (not shown). Next, the vacuum pump is operated to reduce the pressure within the vacuum chamber 10 to a predetermined vacuum state. The unit panel handling device then lowers the unit panel 1 such that the liquid crystal injection hole 16 contacts a surface of the supply of liquid crystal material 14. After contact is established, liquid crystal material 14 contained within the container 12 can be drawn through the liquid crystal injection hole 16 and into the cell gap of the unit panel 1. The injection method described above, therefore, is generally known as a dipping injection method.

After contact is established, the rate at which the liquid crystal material 14 is drawn into the cell gap of the unit panel 1 can be increased by pumping nitrogen gas (N₂) into the vacuum chamber 10, thereby increasing the pressure within the vacuum chamber 10. As the pressure within the vacuum chamber 10 increases, a pressure differential is created between the cell gap of the unit panel 1 and the interior of the vacuum chamber 10. Accordingly, more liquid crystal material 14 contained by the container 12 can be injected into the cell gap of the unit panel 1 and at an increased injection rate. As mentioned above, once the liquid crystal material 14 completely fills the cell gap of the unit panel 1, the injection hole 16 is sealed by a sealant and the injected liquid crystal material 14 is sealed within the unit panel 1. The injection method described above, therefore, is generally known as a vacuum injection method.

Despite their usefulness, the aforementioned dipping and vacuum injection methods can be problematic for several reasons.

First, the total amount of time required to completely fill the cell gap of the unit panel 1 with liquid crystal material 14, according to the dipping/vacuum injection methods, can be relatively long. Specifically, a cell gap thickness of the unit panel 1 is only a few micrometers wide. Therefore, only a small amount of liquid crystal material 14 can be injected into the unit panel 1 per unit time. For example, it can takes about 8 hours to completely inject liquid crystal material 14 into the cell gap of a 15-inch liquid crystal display panel, thereby reducing the efficiency with which LCD devices can be fabricated.

Second, the aforementioned dipping/vacuum injection methods require an excessively large amount of liquid crystal material 14 compared to the relatively small amount of liquid crystal material 14 actually injected into the unit panel 1. Because liquid crystal material 14 contained by the container 12 is exposed to the atmosphere, or certain other process gases during loading and unloading of the unit panel 1 into and out of the vacuum chamber 10, liquid crystal material 14 contained by the container 12 can easily become contaminated. Therefore, the uninjected liquid crystal material 14 must be discarded, thereby reducing the efficiency with which expensive liquid crystal material is used and increasing the cost of fabricating a unit panel 1.

### SUMMARY OF THE INVENTION

Accordingly, the present invention is directed to an apparatus and method of dispensing liquid crystal material that substantially obviates one or more of the problems due to limitations and disadvantages of the related art.

An advantage of the present invention provides a liquid crystal dispensing apparatus capable of dispensing liquid crystal material directly onto a large glass substrate including at least one liquid crystal panel, and a dispensing method thereof.

Another advantage of the present invention provides a liquid crystal dispensing apparatus capable of checking the amount of liquid crystal material remaining within a liquid crystal material container during dispensing of the liquid crystal material by measuring the weight of the remaining liquid crystal material in real time.

To achieve these and other advantages and in accordance with the purpose of the present invention, as embodied and broadly described herein, there is provided a liquid crystal dispensing apparatus, comprising: a liquid crystal material container containing liquid crystal material; a discharge pump for drawing in the liquid crystal material from the liquid crystal material container and discharging the drawn liquid crystal material; a nozzle for dispensing the discharged liquid crystal material; and a weight measuring device for measuring the weight of liquid crystal material remaining in the liquid crystal material container.

The discharge pump comprises: a cylinder having a suction opening and a discharge opening; and a piston inserted in the cylinder and having a groove at its lower portion, the piston drawing in the liquid crystal material through the suction opening and discharging the liquid crystal material through the discharge opening. The weight measuring device includes a load cell installed at a fixing unit and measures the weight of the liquid crystal container put thereon.

It is to be understood that both the foregoing general description and the following detailed description are exemplary and explanatory and are intended to provide further explanation of the invention as claimed. The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 illustrates a cross sectional view of a related art LCD device;

FIG. 2 illustrates a flow chart of a related art method for fabricating the LCD device;

FIG. 3 illustrates a related art liquid crystal injection system for fabricating the related art LCD device;

FIG. 4 illustrates an LCD device fabricated in accordance with a liquid crystal dispensing method of the present invention;

FIG. 5A illustrates a flow chart of a general method of fabricating an LCD device according to a liquid crystal dispensing method of the present invention;

FIG. 5B illustrates a flowchart of a method of dispensing liquid crystal (LC) in fabricating an LCD device according to an embodiment of the present invention;

FIG. 6 illustrates a liquid crystal dispensing method;

FIG. 7 illustrates a perspective view of a liquid crystal dispensing apparatus according to the present invention;

FIG. 8 illustrates an exploded perspective view of the liquid crystal dispensing apparatus according to the present invention;

FIG. 9A illustrates a perspective view of a liquid crystal discharge pump of the liquid crystal dispensing apparatus according to the present invention;

FIG. 9B illustrates an exploded perspective view of the liquid crystal discharge pump;

FIG. 10 illustrates a view of the liquid crystal discharge pump fixed to a fixing member;

FIGS. 11A to 11D are operational views of the liquid crystal discharge pump according to the present invention; and

FIG. 12 illustrates a view of the liquid crystal discharge pump fixed to a fixing member at an increased fixation angle.

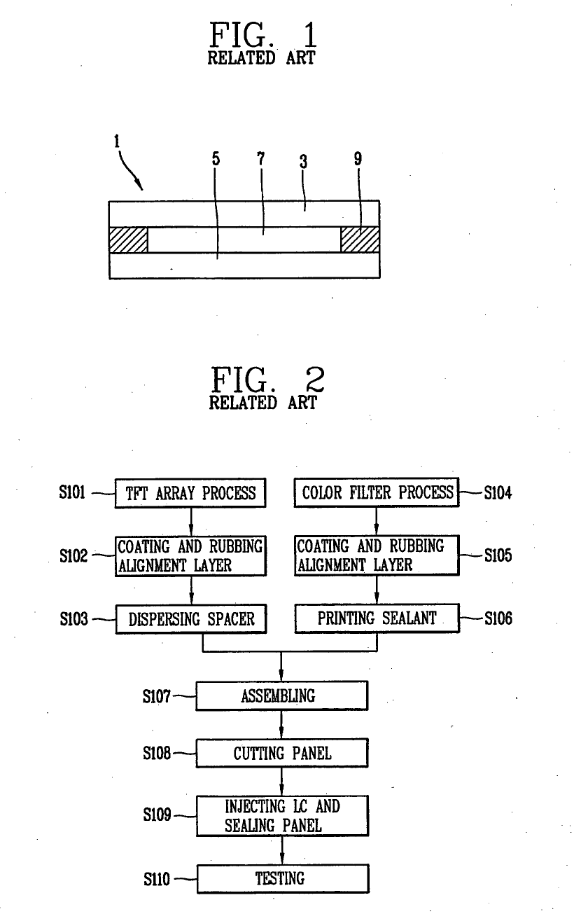

### DETAILED DESCRIPTION OF THE ILLUSTRATED EMBODIMENTS

Reference will now be made in detail to the embodiments of the present invention, examples of which are illustrated in the accompanying drawings.

To resolve problems associated with the aforementioned related art dipping/vacuum injection methods, a liquid crystal dispensing method has been proposed. According to the liquid crystal dispensing method, a liquid crystal layer may be formed by dispensing liquid crystal material directly onto one of the upper or lower substrates. Subsequently, the dispensed liquid crystal material is spread over the substrate upon pressing and bonding the upper and lower substrates together (i.e., assembling the upper and lower substrates). Accordingly, liquid crystal layers may be formed quicker by employing the liquid crystal dispensing method than by employing the related art dipping/vacuum injection methods. Further, the liquid crystal dispensing method consumes less liquid crystal material than either of the related art dipping/vacuum injection methods.

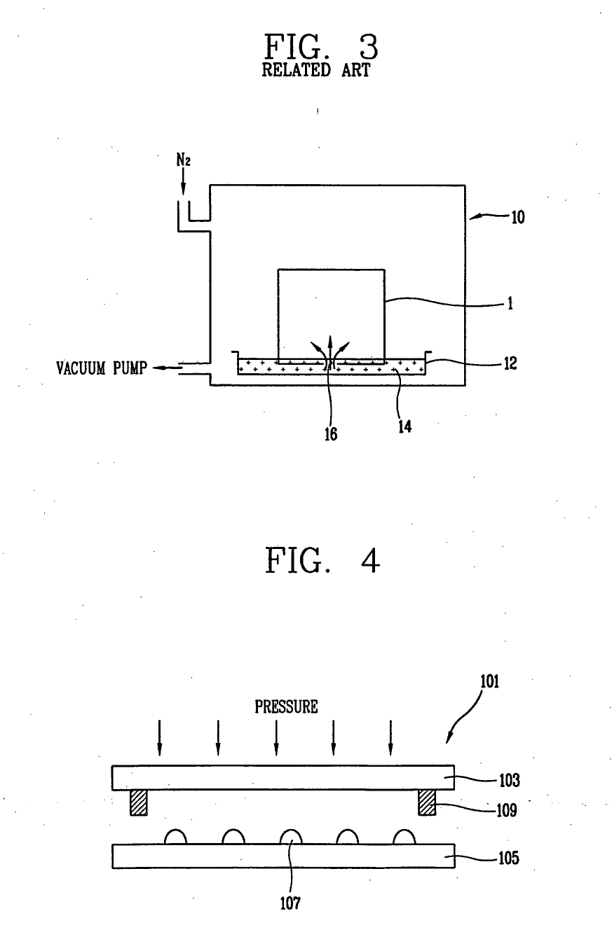

FIG. 4 illustrates a cross sectional view of an LCD device fabricated by applying the liquid crystal dispensing method.

Referring to FIG. 4, liquid crystal material 107 is dispensed as droplets directly onto a lower substrate 105 prior to assembling the lower substrate 105 and an upper substrate 103. The lower substrate 105 includes the aforementioned TFT array substrate, and the upper substrate 103 includes the aforementioned color filter (CF) substrate. The liquid crystal material 107 may be dispensed onto the upper substrate 103. Namely, the substrate on which the liquid crystal material is dispensed by the liquid crystal dispensing method may be either the TFT substrate or the CF substrate. However, when the two substrates are bonded, the substrate on which the liquid crystal material has been dispensed should be laid at the lower portion.

Sealant material 109 is applied to peripheral regions of the upper substrate 103. As mentioned above, the dispensed liquid crystal material 107 spreads between the lower and upper substrates 105 and 103 as the substrates are pressed and bonded together to form an LCD panel 101 having a liquid crystal layer with a substantially uniform thickness. Specifically, in the present invention, the liquid crystal material 107 is dispensed onto the lower substrate and then the lower and upper substrates are bonded together by the sealant material 109.

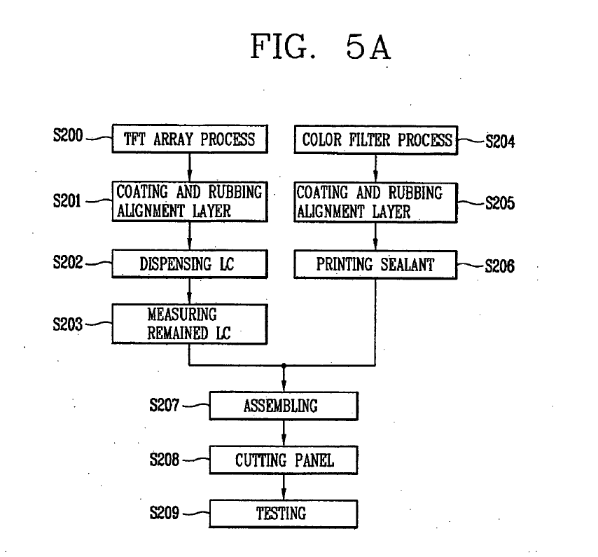

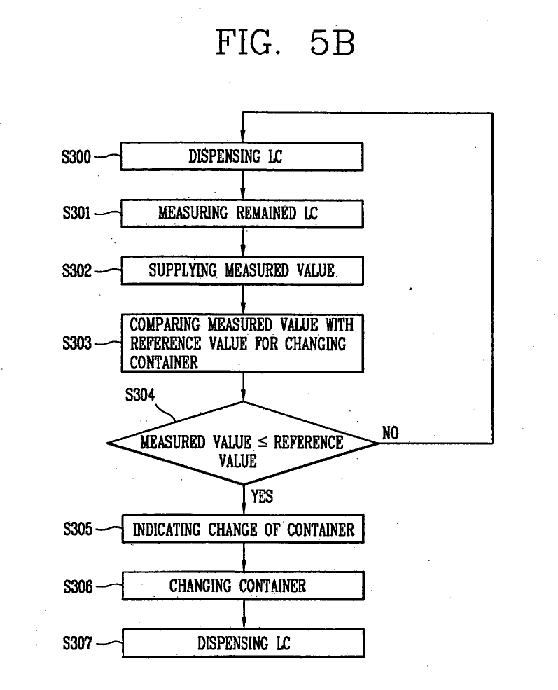

FIG. 5 illustrates a flow chart of a method of fabricating an LCD device according to a liquid crystal dispensing method of the present invention.

At steps S200 and S204, an array of driving devices, such as TFTs, is formed on lower substrate 105 in a TFT array substrate forming process, and a color filter is formed on an upper substrate 103 in a color filter substrate forming process. These two processes may be performed in the same manner as the related art fabrication method illustrated in FIG. 2, and are performed on large glass substrates in which a plurality of panel regions are formed. The fabrication method in accordance with the present invention may be effectively used for glass substrates having a larger area of at least about 100×1200 mm² as compared to the related art fabrication method.

At steps S201 and S205, alignment layers are formed over the entire surface of both the lower and upper substrates 105 and 103 and then rubbed or photo-aligned. At step S202, liquid crystal material is dispensed directly onto a unit panel area defined on the lower substrate 105. While the present figure illustrates dispensing the LC onto the TFT array substrate, it should be appreciated that the LC may be dispensed onto the color filter substrate. At step S203, the liquid crystal remaining in the liquid crystal dispensing device 120 is measured. At step S206, sealant material is provided (e.g., printed) at peripheral regions of a unit panel area defined on the upper substrate 103.

At step S207, the upper and lower substrates 103 and 105 are aligned and subsequently pressed and bonded together (i.e., assembled). Upon assembling the upper and lower substrates 103 and 105, the dispensed liquid crystal material is evenly spread between the upper and lower substrates within a region defined by the sealant material.

At step S208, the assembled upper and lower substrates are cut into a plurality of unit LCD panels. Finally, at step S209, the unit LCD panels are tested.

In view of the discussion above, fabricating unit LCD panels using the liquid crystal dispensing method shown in FIG. 5 is different from fabricating unit LCD panels using the related art dipping/vacuum injection methods shown in FIG. 2.

Specifically, the related art fabrication method processes as illustrated in FIG. 2 involve injecting liquid crystal material into a predetermined cell gap through a liquid crystal injection hole defined within sealant material followed by sealing the liquid crystal injection hole. Although not shown in FIG. 2, upon injecting the liquid crystal material into the cell gap of the unit panel, outer surfaces of the unit panel 1 contact liquid crystal material 14 contained within the container and must be washed after the cell gap is completely filled within liquid crystal material.

The liquid crystal dispensing processes illustrated in FIG. 5, however, involve dispensing liquid crystal material directly onto a substrate, thereby eliminating the need to form any subsequent seal or liquid crystal injection hole. Moreover, because the liquid crystal material is dispensed directly onto the substrate, outer surfaces of a subsequent LCD panel need not be washed to remove liquid crystal material. Accordingly, LCD panels may be fabricated more simply using the liquid crystal dispensing method than using the related art dipping/vacuum injection methods. Further, the liquid crystal dispensing method has a higher yield than the related art dipping/vacuum injection methods.

To fabricate LCD panels using the liquid crystal dispensing method, dispensing positions (i.e., positions on a substrate where droplets of liquid crystal material are to be dispensed) and dispensing amounts (i.e., amounts of liquid crystal material within each droplet of liquid crystal material) heavily influence the formation of a liquid crystal layer having a desired thickness. Because the thickness of a liquid crystal layer is closely related to a cell gap of the LCD panel, dispensing positions and amounts must be controlled precisely to avoid fabricating a defective LCD panel. Accordingly, the principles of the present invention provide a liquid crystal dispensing apparatus that ensures that actual dispensing positions and amounts are precisely controlled to match predetermined dispensing positions and amounts.

A more specific illustration of a method of dispensing the liquid crystal according to an embodiment of the present invention is provided at FIG. 5B. As illustrated, at step S300, liquid crystal is dispensed onto a glass substrate. This step is akin to step S202 of FIG. 5A. At step S301, the liquid crystal remaining in the liquid crystal dispensing device is measured. The measured value is provided at step S302 so that a comparison can be made between the measured value of the remaining LC and a reference value at step S303. As illustrated by step S304, if the measured value of the remaining LC is not less than the reference value, a next dispensing step S300 may be performed. If the measured value of the remaining LC is less than the reference value, an indication that the LC container should be changed is provided at step S305. The LC container is changed at step S306 and operation of the dispensing LC is resumed at step S307.

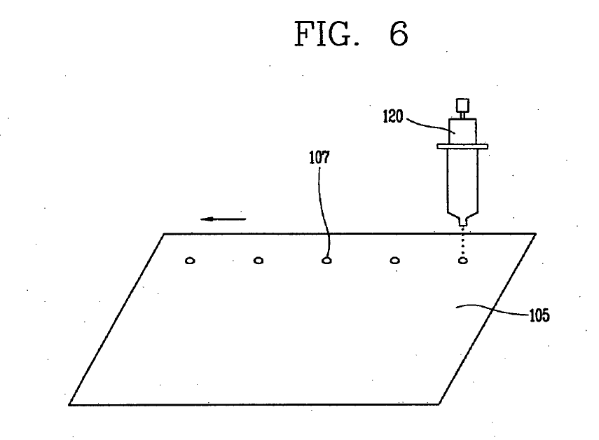

FIG. 6 illustrates a liquid crystal dispensing method in accordance with principles of the present invention.

Referring to FIG. 6, the liquid crystal dispensing apparatus is arranged above the lower substrate 105 (e.g., a glass substrate). Further, droplets of liquid crystal material are dispensed from the liquid crystal dispensing apparatus 120.

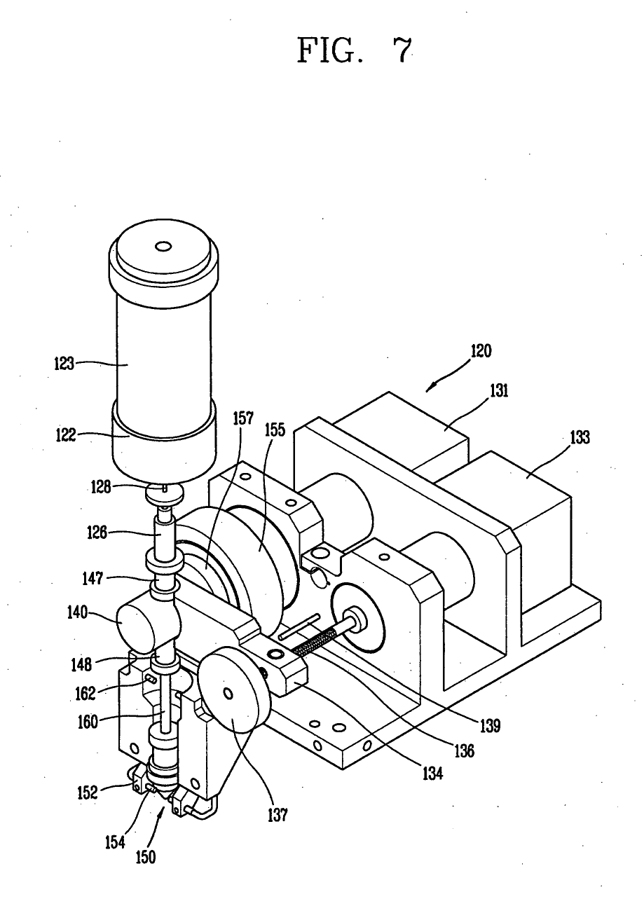

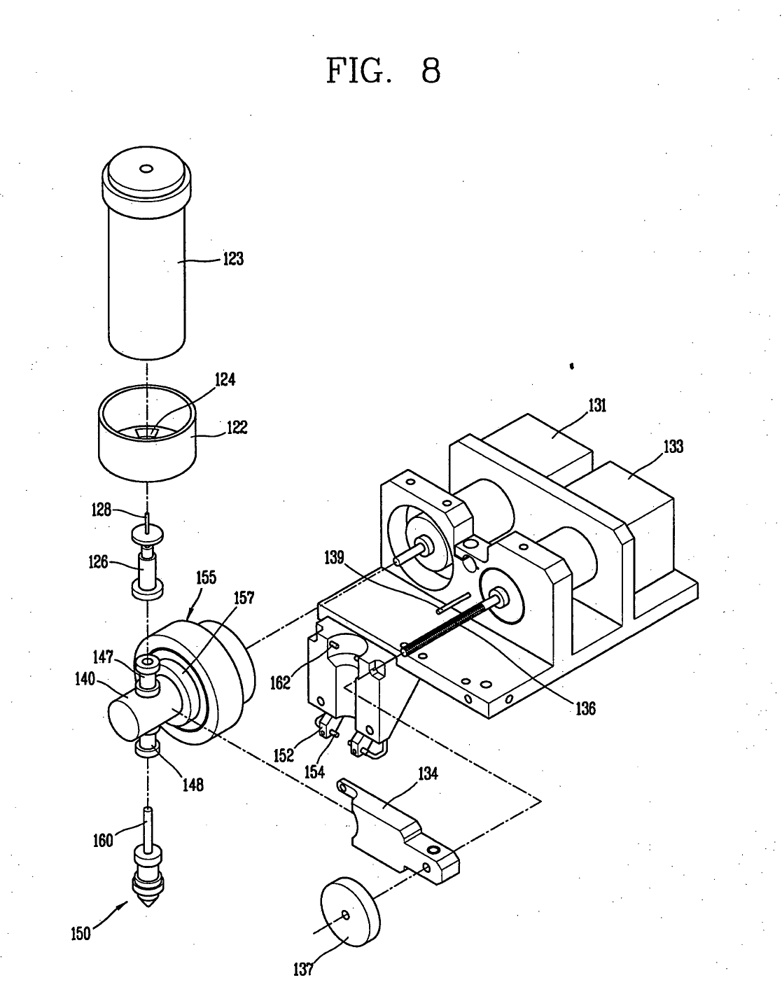

FIG. 7 illustrates a perspective view of a liquid crystal dispensing apparatus according to principles of the present invention, and FIG. 8 illustrates an exploded perspective view of the liquid crystal dispensing apparatus.

Referring to FIGS. 7 and 8, the liquid crystal dispensing apparatus 120 of the present invention includes a cylindrical liquid crystal material container 123 filled with liquid crystal material and fixed by and accommodated within a container fixing unit 122.

The liquid crystal material container 123 may be formed of polyethylene. Since polyethylene is substantially inert with respect to the liquid crystal material, the liquid crystal material container 123 formed of polyethylene may prevent liquid crystal material from chemically reacting with sidewalls of the liquid crystal material container 123. Also, because polyethylene is an easily deformable material, the container may be fabricated as a desired shape.

However, the liquid crystal material container may be formed of a metallic material such as stainless steel and the interior walls of the liquid crystal container 123 may be coated with a material such as a fluorine resin to prevent liquid crystal material from chemically reacting with sidewalls of the liquid crystal material container 123.

A gas supply tube (not shown) is arranged at an upper portion of the liquid crystal material container 123 to transport an inert gas (e.g., nitrogen) into portions of the liquid crystal material container 123 that are not occupied by the liquid crystal, material contained therein. The gas is used to pressurize the liquid crystal material container 123, facilitating the liquid crystal material contained therein to be dispensed onto the substrate.

Referring to FIG. 8, according to principles of the present invention, at least one weight measurement device (scale) 124 (e.g., a load cell) is arranged on a bottom of the container fixing unit 122. The weight measuring device measures the weight of the liquid crystal material container 123 containing the liquid crystal material as the container 123 is put thereon to be fixed to the container fixing unit 122. Because the weight measuring device 124 is set to indicate a zero point with respect to the container's own weight, the weight of the liquid crystal material remaining within the container 123 can be measured. Then the weight measuring device 124 converts the measured weight into a volume and outputs its volume.

A liquid crystal discharge pump 140 is arranged at a lower portion of the container 123. The liquid crystal discharge pump 140 is used to discharge a certain amount of liquid crystal material, contained within the container 123, onto a substrate. Therefore, a liquid crystal suction opening 147 and a liquid crystal discharge opening 148 are formed at opposing sides of the liquid crystal discharge pump 140. During an operation of the liquid crystal dispensing apparatus 120, the liquid crystal suction opening 147 conveys liquid crystal material drawn from the container 123 into the liquid crystal discharge pump 140. Similarly, during an operation of the liquid crystal dispensing apparatus 120, the liquid crystal discharge opening 148 conveys liquid crystal material discharged from the liquid crystal discharge pump 140 to a nozzle 150.

As illustrated in FIG. 8, a first connecting tube 126 is coupled to the liquid crystal suction opening 147. In one aspect of the present invention, the liquid crystal suction opening 147 may be coupled to the first connecting tube 126 by being inserted into the first connecting tube 126. In another aspect of the present invention, the liquid crystal suction opening 147 may be coupled to the first connecting unit 126 via a coupling means (e.g., a screw, or the like).

A hole (or window) (not shown) is formed at a center portion of the bottom of the container fixing unit 122 where the liquid crystal material container 123 is fixed, thereby exposing a lower surface of the liquid crystal material container 123 to the outside. A hollow pin 128 (e.g., an injection needle) is formed at one side of the first connecting tube 126 and a pad (not shown), formed of a highly compressible material and capable of forming a hermetic seal (e.g., silicon, butyl rubber material, or the like), is arranged at a lower portion of the container 123. The pin 128 is inserted through the pad and into the container 123. Upon insertion of the pin 128, the pad presses against the outside wall of the pin 128, preventing liquid crystal material from leaking outside of the pin 128, and liquid crystal material contained within the container 123 is transported into the liquid crystal suction opening 147. Because the liquid crystal suction opening 147 and the container 123 are coupled to each other via the pin/pad structure discussed above, the liquid crystal suction opening 147 may be simply coupled and decoupled to the container 123.

The liquid crystal suction opening 147 may be integrally formed with the first connecting tube 126. In this case, the pin 128 is formed at the liquid crystal suction opening 147 and is inserted directly into the liquid crystal material container 123 via the pad, such that the liquid crystal material within the container 123 is transported into the liquid crystal suction opening 147. Therefore, the structure may be simplified.

The first connecting tube 126 connected to the liquid crystal suction opening 147 may not be connected to the container 123 by the pin/pad structure, but may be connected to a hole formed at an upper portion or a side of the liquid crystal container 147. During an operation of the liquid crystal discharge pump 140, the liquid crystal material within the liquid crystal material container 123 is transported into the liquid crystal discharge pump 140 through the liquid crystal suction opening 147.

A nozzle 150 is arranged at a lower portion of the liquid crystal discharge pump 140. The nozzle 150 is connected to the liquid crystal discharge opening 148 of the liquid crystal discharge pump 140 via a second connecting tube 160 to facilitate the dispensing of liquid crystal material discharged from the liquid crystal discharge pump 140 onto the substrate.

The second connecting tube 160 may be formed of an opaque material or may be formed of a transparent material. The reason of forming the second connecting tube 160 of a transparent material is as follows.

When liquid crystal material contains vapor, dispensing amounts of dispensed liquid crystal material cannot be precisely controlled. However, the liquid crystal material contained within the liquid crystal material container 123 may, at some point, contain vapor. Also, vapor may be introduced into the liquid crystal material at the liquid crystal discharge pump 140. The presence and amount of vapor cannot be precisely controlled nor can it be completely removed before the liquid crystal material is dispensed onto the substrate, even if a vapor-removing device is employed. Therefore, the best way to prevent the dispensing amounts from being imprecisely controlled and thus to prevent a defective LCD panel from being fabricated is to stop the operation of the liquid crystal dispensing apparatus and remove the vapor as soon as it is determined that vapor is present.

Accordingly, the second connecting tube 160 may be formed of a transparent material, enabling a suitable visual inspection to determine the presence of vapor contained within the liquid crystal material and preventing the fabrication of a defective LCD panel. Vapor may be detected with the naked eye, but a first sensor 162 (e.g., a photo coupler, or the like) may be arranged at opposing sides of the second connecting tube 160 to automatically detect the presence of vapor within the discharged liquid crystal material.

A protection unit 152 is arranged at both sides of the nozzle 150 into which the discharged liquid crystal material is introduced via the second connecting tube 160 and protects the nozzle 150 from external stresses, etc. Further, a second sensor 154 is arranged at the protection unit 152 of the nozzle 150 to detect the presence of vapor within the liquid crystal material dispensed from the nozzle 150 and/or to detect the presence of liquid crystal material accumulated on the surface of the nozzle 150.

The actual amount of liquid crystal material dispensed may deviate from the predetermined amount when liquid crystal material is accumulated on the surface of the nozzle 150. Because the liquid crystal material spreads over the nozzle 150, the amount of liquid crystal material actually dispensed onto the substrate as a droplet is less than the predetermined amount. Moreover, portions of the residual liquid crystal material accumulated on the surface of the nozzle 150 may be dispensed onto the substrate, resulting in the fabrication of a defective LCD panel. Therefore, to prevent the accumulation of residual liquid crystal material on the surface of the nozzle 150, a material forming a large contact angle with liquid crystal material, namely, a hydrophobic material such as fluorine resin or the like may be deposited on the substrate of the nozzle 150 by any suitable method (e.g., dipping, spraying, or the like). As a result, by providing the nozzle 150 with the material like a fluorine resin, liquid crystal material does not spread over the surface of the nozzle 150, but is dispensed onto the substrate through the nozzle 150 as a complete droplet.

Meanwhile, the liquid crystal discharge pump 140 is inserted into a rotating member 157. The rotating member 157 is fixed to a fixing unit 155 and connected to a first motor 131. Therefore, as the first motor 131 is operated, the rotating member 157 rotates, which, in turn, causes the liquid crystal discharge pump 140 fixed to the rotating member 157 to operate.

Therefore, the liquid crystal discharge pump 140 contacts one side of a bar-shaped liquid crystal capacity amount controlling member 134. A hole is formed at the other side of the liquid crystal capacity amount controlling member 134 and a rotational shaft 136 is inserted into the hole. A screw is formed at a periphery of the hole and the rotational shaft 136 so as to couple the liquid crystal capacity amount controlling member 134 to the rotational shaft 136. Also, one end of the rotational shaft 136 is connected to a second motor 133 and the other end is connected to a control lever 137.

The amount of liquid crystal material dispensed by the liquid crystal discharge pump 140 is varied in accordance with a fixation angle between the liquid crystal discharge pump 140 and the rotating member 157 (i.e., the angle at which a portion of the liquid crystal discharge pump 140 is fixed to the rotating member 157). Namely, the liquid crystal capacity amount of the liquid crystal discharge pump 140 is varied in accordance with the fixation angle. The rotational shaft 136 is rotated either automatically upon driving the second motor 133 or manually upon operating the control lever 137. Upon rotating the rotational shaft 136, one end of the liquid crystal capacity amount controlling member 134 which is screw-coupled to the rotational shaft 136 moves along a linear axis of the rotational shaft 136. According to the movement of one end of the liquid crystal capacity amount controlling member 134, a force supplied to the liquid crystal discharge pump 140 is changed and accordingly, the fixation angle of the liquid crystal discharge pump 140 is also changed.

Accordingly, the first motor 131 operates to cause the liquid crystal discharge pump 140 to dispense liquid crystal material from the liquid crystal material container 123 onto the substrate, while the second motor 133 operates to control the fixation angle and thus to control the amount of liquid crystal material dispensed by the liquid crystal discharge pump 140 during its operation.

The amount of liquid crystal material dispensed as one droplet is very minute, and variations in the dispensing amount are also very minute. Therefore, minute variations in an inclined angle (i.e., the fixation angle) of the liquid crystal discharge pump must be precisely controlled to control the discharge amount of the liquid crystal discharge pump 140. To effect such precise control in the fixation angle, the second motor 133 may be provided as a step motor operated by a pulse input value.

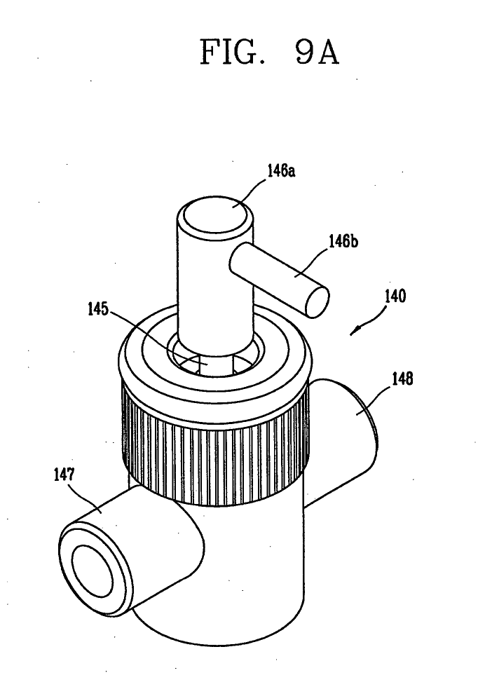

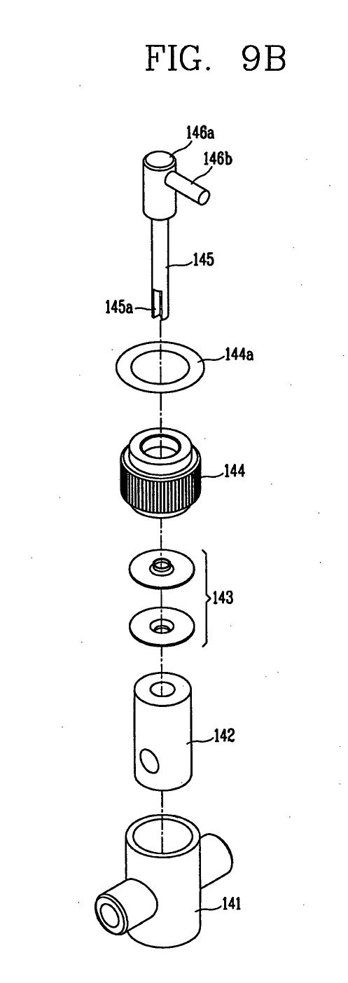

FIG. 9A illustrates a perspective view of a liquid crystal discharge pump of the liquid crystal dispensing apparatus. FIG. 9B illustrates an exploded perspective view of the liquid crystal discharge pump.

Referring to FIGS. 9A and 9B, the liquid crystal discharge pump 140 includes: a case 141 wherein the case 141 includes the liquid crystal suction and discharge openings 147 and 148; a cap 144 coupled to the case 141, wherein an upper portion of the cap 144 includes an opening; a cylinder 142 inserted in the case 141 for conveying liquid crystal material drawn from the liquid crystal container 123; a sealing device 143 for sealing the cylinder 142; an o-ring 144a arranged at an upper portion of the cap 144 for preventing liquid crystal material from leaking outside the liquid crystal discharge pump 140; and a piston 145 inserted in the cylinder 142 through the opening of the cap 144, the piston 145 being rotated and moving upwardly and downwardly within the cylinder 142 for drawing in and discharging liquid crystal material through the liquid crystal suction opening 147 and the liquid crystal discharge opening 148, respectively. A head 146a is arranged at an upper portion of the piston 145 and fixed to the rotating member 157 (FIG. 8), and a bar 146b is arranged at the head 146a. The bar 145 is inserted in and fixed to a hole (not shown) of the rotating member 157. Accordingly, the piston 145 may rotate when the rotating member 157 is rotated by the first motor 131.

A groove 145a is formed at an end portion of the piston 145. The groove 145a occupies no more than about 25% of a cross-sectional area of the piston 145. The groove 145a may open and close the liquid crystal suction opening 147 and the liquid crystal discharge opening 148 upon rotating the piston 145 to draw in and discharge liquid crystal material through the liquid crystal suction opening 147 and to the liquid crystal discharge opening 148.

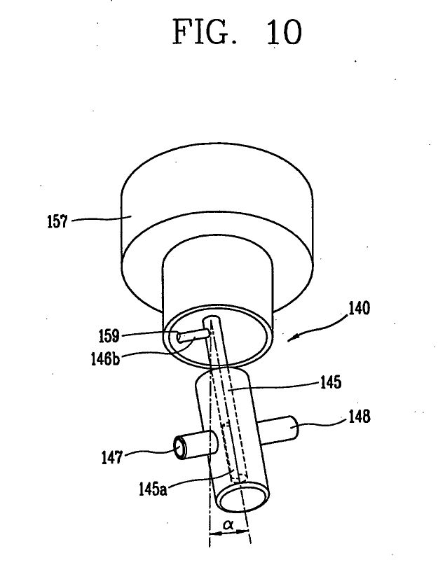

An operation of the liquid crystal discharge pump 140 will now be explained in greater detail below with reference to FIG. 10.

FIG. 10 illustrates a view of the liquid crystal discharge pump 140 fixed to a rotating member 157.

Referring to FIG. 10, the piston 145 of the liquid crystal discharge pump 140 is fixed to the rotating member 157 at a predetermined angle, a (i.e., the fixation angle). The bar 146b formed at the piston head 146a is inserted into a hole 159 formed within the rotating member 157 to couple the piston 146 to the rotating member 157. A bearing (not shown) is provided within the hole 159 to allow the bar 146b of the piston 145 to move in back and forth and right and left directions with respect to the hole 159. Upon operating the first motor 131, the rotating member 157 is rotated, thereby rotating the piston 145 coupled (i.e., fixed) to the rotating member 157.

If the fixation angle (α) of the liquid crystal discharge pump with respect to the rotating member 157, namely, the fixation angle (α) of the piston 145 with respect to the rotating member 157, is 0°, the piston 145 rotates only according to the rotating movement of the rotating member 157. However, since the fixation angle (α) of the piston 145 with respect to the rotating member 157 is substantially not 0° (i.e., since the piston is fixed at a certain angle), the piston 145 rotates according to the rotating movement of the rotating member 157 and simultaneously moves vertically.

The piston 145 is rotated a predetermined amount within an interior space of the cylinder 142 and moves upwardly, thereby creating a void in the cylinder 142. Liquid crystal material within the liquid crystal suction opening 147 is drawn into the void of the cylinder 142. Upon rotating the piston 145 within the cylinder further, the piston 145 moves downwardly, discharging the liquid crystal material, which has been drawn into the cylinder 142, into the liquid crystal discharge opening 148. During the aforementioned drawing-in (or suction) and discharge operations, the groove 145a formed at the piston 145 opens and closes the liquid crystal suction opening 147 and the liquid crystal discharge opening 148 by the rotation of the piston 145.

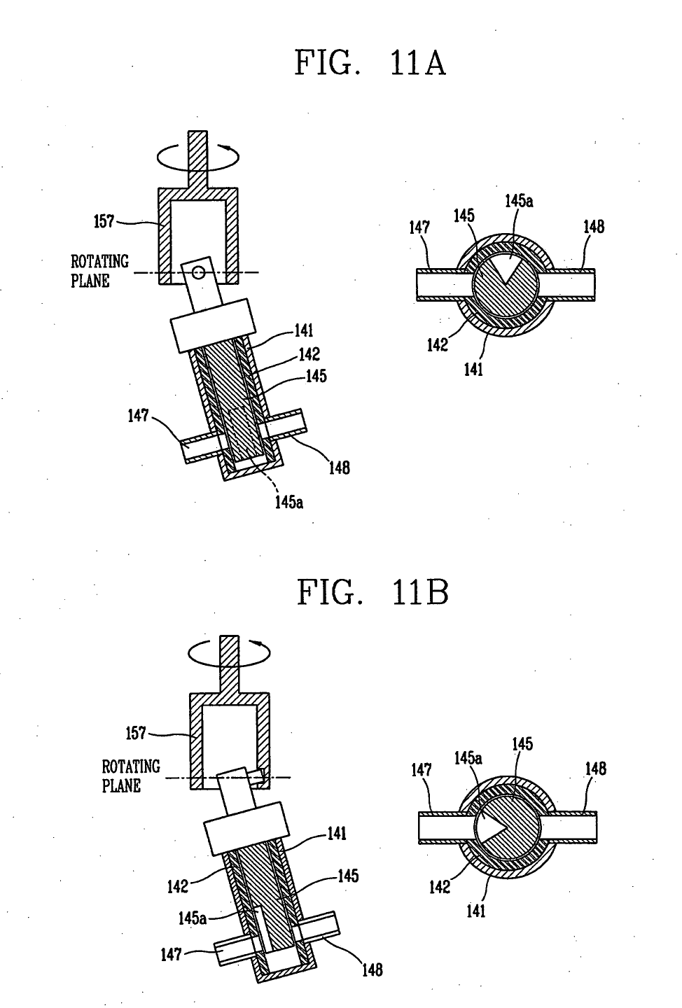

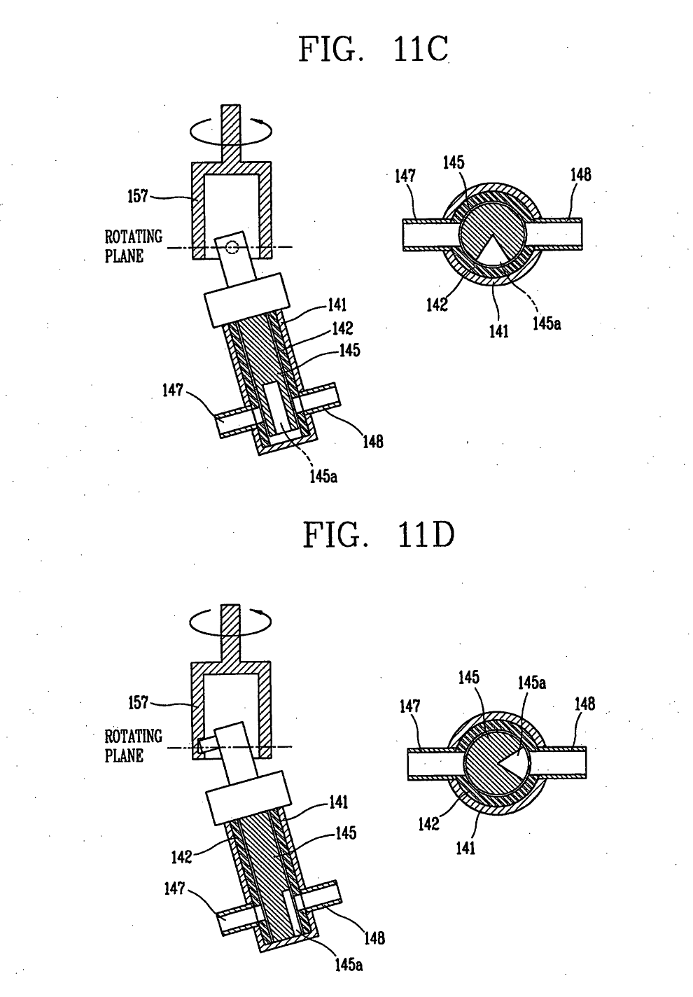

The operation of the liquid crystal discharge pump 140 will now be described in greater detail with respect to FIGS. 11A to 11D.

Referring to FIGS. 11A to 11D, liquid crystal material contained within the liquid crystal material container 123 is discharged to the nozzle 150 through four strokes of the liquid crystal discharge pump 140. FIGS. 11A and 11C illustrate cross strokes; FIG. 11B illustrates a suction stroke at the liquid crystal suction opening 147; and FIG. 11D illustrates a discharge stroke at the liquid crystal discharge opening 148.

Referring to FIG. 11A, the piston 145 fixed to the rotating member 157 at a certain fixation angle (α), rotates in accordance with the rotation of the rotating member 157. In the cross stroke shown in FIG. 11A, the piston 145 closes both the liquid crystal suction opening 147 and the liquid crystal discharge opening 148.

Upon rotating the rotating member 157 approximately 45°, the piston 145 rotates within the cylinder 142 to arrange the groove 145a to open the liquid crystal suction opening 147 (i.e., to be in fluid communication with the liquid crystal suction opening 147) as shown in FIG. 11B. The bar 146b of the piston 145 is inserted in the hole 159 of the rotating member 157 to couple the rotating member 157 to the piston 145. Accordingly, the piston 145 rotates according to the rotation of the rotating member 157 while the bar 146b rotates along a rotation plane.

Because the piston 145 is fixed to the rotating member 157 at a predetermined fixation angle and the bar 146b rotates along the rotation plane, the piston 145 moves upwardly according to the rotation of the rotating member 157, leaving a space in the fixed cylinder 142 thereunder. Thus, liquid crystal material is drawn into the space of the cylinder 142 through the liquid crystal suction opening 147 opened by the groove 145a.

After the suction stroke is started (i.e., after the liquid crystal suction opening 147 is opened), the suction of the liquid crystal material is continued until a cross stroke as shown in FIG. 11C is started (i.e., until the liquid crystal suction opening 147 is closed) upon further rotating the rotating member 157 approximately 45°.

Referring to FIG. 11D, upon further rotating the rotating member 157, the piston 145 moves downwardly and rotates within the cylinder 142 to arrange the groove to open the liquid crystal discharge opening 148 (i.e., to be in fluid communication with the liquid crystal discharge opening 148). Upon arranging the groove 145a to open the liquid crystal discharge opening 148, liquid crystal material is discharged from the cylinder 142 and groove 145a through the liquid crystal discharge opening 148 (discharge stroke).

As described above, the liquid crystal discharge pump 140 repeats four consecutive strokes (i.e., the first cross stroke, the suction stroke, the second cross stroke, and the discharge stroke), to discharge the liquid crystal material contained in the liquid crystal material container 123, to the nozzle 140.

The amount of liquid crystal material discharged by the liquid crystal discharge pump 140 may be varied according to the degree to which the piston 145 moves upwardly and downwardly. Here, the degree to which the piston 145 moves is regulated by the fixation angle at which the liquid crystal discharge pump 140 is fixed to the rotating member 157.

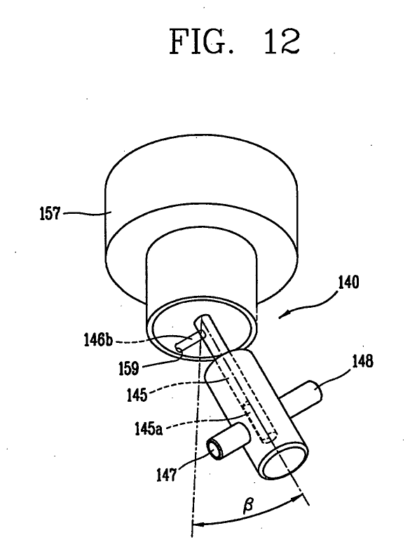

FIG. 12 illustrates a view of the liquid crystal discharge pump fixed to the rotating member at a predetermined angle β.

As described above with respect to FIG. 10, the liquid crystal discharge pump 140 shown in FIG. 10 is fixed to the rotating member 157 at a fixation angle α. However, as shown in FIG. 12, the liquid crystal discharge pump 140 is fixed to the rotating member 157 at a fixation angle of β, wherein β>α. Accordingly, the degree of an ascent of the piston 145, with respect to the rotating member 157 shown in FIG. 12 is greater than the degree of an ascent of the piston 145 shown in FIG. 10. Accordingly, as the fixation angle increases, the degree to which the piston moves upwardly increases, thereby increasing the amount of liquid crystal material drawn into the cylinder 142. This also means that the amount of liquid crystal material discharged may be controlled by the fixation angle.

In one aspect of the present invention, the fixation angle is controlled by the liquid crystal capacity amount controlling member 134 shown in FIG. 7. The liquid crystal capacity controlling member 134 is moved by driving the second motor 133. Therefore, the fixation angle of the liquid crystal discharge pump 140 may be controlled by controlling the second motor 133.

Alternatively, the fixation angle may be controlled by manually adjusting an angle controlling lever 137. However, this method is problematic since accurate adjustment is impossible, it takes a long time to perform the adjusting process and the operation of the liquid crystal discharge pump must be interrupted. Accordingly, it is preferable that the fixation angle of the liquid crystal discharge pump 140 is controlled by the second motor 133.

The fixation angle of the liquid crystal discharge pump 140 is measured by a sensor 139 such as a linear variable differential transformer. If the fixation angle exceeds a predetermined angle, the sensor 139 communicates an alarm to a user, preventing the liquid crystal discharge pump 140 from being damaged.

In the liquid crystal dispensing apparatus 120, the amount of liquid crystal material within the liquid crystal container 123 is decreased as the liquid crystal material is dispensed onto the substrate upon operating the liquid crystal discharge pump 140. During a dispensing operation of the liquid crystal material, an operator should check the amount of liquid crystal material remaining in the liquid crystal material container 123. The reason thereof will now be described in greater detail.

The liquid crystal material container 123 of the liquid crystal dispensing apparatus is filled with a limited amount of liquid crystal material. Therefore, after a certain amount of liquid crystal material is dispensed onto the predetermined number of substrates, the container 123 should be refilled with liquid crystal material. However, the predetermined amount of liquid crystal material is not necessarily dispensed onto the substrate. Due to various factors, the amount of liquid crystal material dispensed may be minutely changed, which causes the actual amount of liquid crystal material dispensed to greatly deviate from the predetermined amount. For instance, if the actual amount of liquid crystal material dispensed is greater than the predetermined amount, the amount of liquid crystal material last dispensed onto a substrate of a plurality of substrates may be less than the predetermined amount. If the amount of liquid crystal material that is less than the predetermined amount is dispensed onto a substrate, a normally black mode LCD device is problematic in a black brightness and a normally white mode LCD device is problematic in a white brightness.

In contrast, if the actual amount of liquid crystal material dispensed is less than the predetermined amount, an excessive amount of liquid crystal material remains in the liquid crystal material container 12 when the dispensing operation is completed. Because the residual liquid crystal material within the container 123 may be exposed to the air when the container is refilled with liquid crystal material and react to components (particularly, moisture) of the air, the residual liquid crystal material should be discarded. Particularly, if the amount of residual amount of liquid crystal material is greater than the predetermined amount of liquid crystal material dispensed, discarding the liquid crystal material may become an obstacle to the cost reduction in fabricating an LCD device.

Accordingly, even though the amount of liquid crystal material dispensed onto a substrate is set, the operator should prevent expensive liquid crystal material from being discarded by always checking the amount of liquid crystal material remaining within the liquid crystal material container 123.

Also, because the liquid crystal material container 123 of the liquid crystal dispensing apparatus 120 is commonly made of an opaque material (stainless steel, polyethylene, or the like), it is impossible for an operator to check the amount of liquid crystal material remaining within the container 123 with the naked eye. Moreover, although a visual inspection is possible, it is impossible to check the amount of liquid crystal material within the container 123 in real time.

However, the present invention solves such problems by providing the liquid crystal dispensing apparatus with a weight measuring device 124. Liquid crystal material dispensed onto the substrate has a density of a specific value. Accordingly, by measuring the weight of the liquid crystal material remaining within the liquid crystal material container 123, a volume of the residual liquid crystal material may be calculated.

With reference to FIGS. 7 and 8, the weight measuring device 124 employed in the present invention is arranged at a container fixing unit 122 on which the liquid crystal material container 123 is put, and is set to indicate a zero point with respect to the empty container 123 containing no liquid crystal material. Accordingly, the weight of the container 123 measured by the weight measuring device 124 represents the weight of liquid crystal material remaining within the container 123. Also, an output unit (not shown) is connected to the weight measuring device 124 to output the measured weight of the remaining liquid crystal material, and a user converts the measured weight into a volume to check the remaining amount of liquid crystal material. Here, by inputting a density of the dispensed liquid crystal material to the output unit, the output unit may output a volume of the liquid crystal material upon converting the measured weight of the liquid crystal material into the volume.

As so far described, in the present invention, the liquid crystal dispensing apparatus is provided with a weight measuring device for measuring the weight of the remaining liquid crystal material. Thus, the amount of liquid crystal material remaining within the liquid crystal material container can be checked during dispensing of the liquid crystal material. As a result, the liquid crystal material may be efficiently used, and the expensive liquid crystal material may be prevented from being wasted. Moreover, the fabrication of a defective LCD panel caused by an insufficient amount of liquid crystal material can be effectively prevented.

In the above description, a measuring device for measuring the weight of liquid crystal material 107, that is, a weight measuring device is arranged at a container fixing unit 122 where a liquid crystal material container 123 is fixed and measures the amount of residual liquid crystal material within the container 123. However, such a structure is only one example of the present invention and the present invention is not limited thereto. It will be apparent to those skilled in the art that various modifications and variation, such as LCD devices employing various mechanical weight measuring devices, electromagnetic weight measuring devices or optical weight measuring devices at various positions, can be made in the present invention without departing from the sprit or scope of the invention. Thus, it is intended that the present invention covers the modification and variations of this invention provided they come within the scope of the appended claims and their equivalence.

What is claimed is:

1. A liquid crystal dispensing apparatus, comprising:
a liquid crystal material container containing liquid crystal material;
a discharge pump for drawing in the liquid crystal material from the liquid crystal material container and discharging the drawn liquid crystal material;
a nozzle for dispensing the discharged liquid crystal material; and
a weight measuring means for measuring the weight of liquid crystal material remaining in the liquid crystal material container.

2. The apparatus of claim 1, wherein the discharge pump comprises:
a cylinder having a suction opening and a discharge opening; and
a piston inserted in the cylinder and having a groove at its lower portion, the piston drawing the liquid crystal material through the suction opening and discharging the liquid crystal material through the discharge opening.

3. The apparatus of claim 2, further comprising a fixing unit to which the discharge pump is fixed.

4. The apparatus of claim 3, wherein the fixing unit comprises a rotating member fixed to the piston of the discharge pump and rotating the piston.

5. The apparatus of claim 4, wherein the piston includes a bar, and the rotating member includes a hole, so that the bar is coupled with the hole to fix the piston to the rotating member.

6. The apparatus of claim 5, wherein the bar is rotatably inserted within the hole.

7. The apparatus of claim 4, wherein the liquid crystal capacity amount of the discharge pump is dependent upon a fixation angle at which the piston is fixed to the rotating member.

8. The apparatus of claim 7, wherein the liquid crystal capacity amount increases as the fixation angle increases.

9. The apparatus of claim 1, further comprising a liquid crystal capacity amount controlling member for controlling the amount of liquid crystal material that is discharged by the discharge pump by changing the fixation angle of the discharge pump in contact with the discharge pump.

10. The apparatus of claim 9, further comprising:
a motor for driving the liquid crystal capacity amount controlling member; and
a rotational shaft coupled to the liquid crystal capacity amount controlling member and rotated upon driving the motor to linearly move the liquid crystal capacity amount controlling member.

11. The apparatus of claim 10, wherein the motor is a sub-motor.

12. The apparatus of claim 10, wherein the motor is a step motor.

13. The apparatus of claim 10, further comprising a control lever arranged at an end portion of the rotational shaft for manually controlling the liquid crystal capacity amount controlling member.

14. The apparatus of claim 1, further comprising:
a first connecting tube for connecting the container with the discharge pump; and
a hollow pin arranged at the end of the first connecting tube, wherein liquid crystal material is drawn into the hollow pin.

15. The apparatus of claim 14, wherein a pad through which the pin is inserted is arranged at the container and presses against the pin, preventing the liquid crystal material from leaking along and outside of the pin.

16. The apparatus of claim 15, wherein the pad is formed a resilient material.

17. The apparatus of claim 16, wherein the resilient material is one of silicon and butyl rubber material.

18. The apparatus of claim 1, further comprising a first connecting tube connecting a hole in the liquid crystal container with the liquid crystal discharge pump.

19. The apparatus of claim 18, wherein the hole is at a side of the liquid crystal container.

20. The apparatus of claim 19, wherein the hole is at the upper portion of the liquid crystal container.

21. The apparatus of claim 1, further comprising a second connecting tube connecting the discharge pump with the nozzle.

22. The apparatus of claim 21, wherein the second connecting tube is formed of a transparent material.

23. The apparatus of claim 21, further comprising a first detecting unit arranged near the second connecting tube for detecting the presence of vapor contained within the liquid crystal material discharged by the discharge pump.

24. The apparatus of claim 1, further comprising a second detecting unit arranged near the nozzle for detecting the accumulation of the liquid crystal material on the surface of the nozzle.

25. The apparatus of claim 1, further comprising a fixing unit to which the liquid crystal material container is fixed.

26. The apparatus of claim 25, wherein the weight measuring device is arranged at the fixing unit.

27. The apparatus of claim 26, wherein the weight measuring device includes at least one load cell.

28. A liquid crystal dispensing apparatus, comprising:
a liquid crystal material container containing liquid crystal material;
a discharging device releasing the liquid crystal material from the container;
a nozzle for dispensing the released liquid crystal material; and
a weight measuring means for measuring the weight of liquid crystal material remaining in the liquid crystal material container.

29. A method of manufacturing a liquid crystal device comprising:
providing first and second substrates;
dispensing liquid crystal material on at least one of the first and second substrates;
attaching the first and second substrates;
wherein, dispensing the liquid crystal material includes:
providing liquid crystal material in a container;
releasing the liquid crystal material from the container;
dispensing the released liquid crystal material on the at least one of the first and second substrates;
measuring an amount of liquid crystal material in the container.

30. The method of claim 29, wherein measuring the amount of liquid crystal is performed after dispensing the released liquid crystal.

31. The method of claim 30, wherein measuring an amount of liquid crystal material in the container provides a measured value of liquid crystal remaining in the container, and further comprising:
comparing the measured value with a reference value; and
providing a new container having liquid crystal if the measured value is less than the reference value.

32. The method of claim 30, wherein measuring an amount of liquid crystal material in the container provides a measured value of liquid crystal remaining in the container, and further comprising:
comparing the measured value with a reference value; and
providing additional liquid crystal to the container if the measured value is less than the reference value.

33. The method of claim 30, wherein the measuring includes determining the weight of the liquid crystal in the container.
